(19) United States
(12) Patent Application Publication
(10) Pub. No.: US 2021/0019906 A1
(43) Pub. Date: Jan. 21, 2021

(54) METHOD AND APPARATUS FOR OBJECT DETECTION INTEGRATING 2D IMAGE RECOGNITION AND 3D SCENE RECONSTRUCTION

(71) Applicant: Hitachi, Ltd., Tokyo (JP)

(72) Inventors: Yuki WATANABE, San Jose, CA (US); Ravigopal VENNELAKANTI, San Jose, CA (US); Manish GUPTA, Sunnyvale, CA (US); Nam HUYN, Milpitas, CA (US); Akira MAEKI, Sunnyvale, CA (US); Chandrasekar VENKATRAMAN, Saratoga, CA (US)

(73) Assignee: Hitachi, Ltd.

(21) Appl. No.: 16/515,867

(22) Filed: Jul. 18, 2019

(51) Int. Cl. G06T 7/70; G06K 9/62; G06T 7/00; G06T 15/06; G06K 9/00; G06T 7/55; G06T 15/08

(52) U.S. Cl. CPC G06T 7/70; G06K 9/6267; G06T 7/0002; G06T 15/06; G06K 9/00201; G06T 2210/21; G06T 15/08; G06T 2207/10028; G06T 2207/30168; G06T 2207/30108; G06T 7/55

(57) ABSTRACT

Example implementations described herein are directed to the projection of two dimensional (2D) image recognition results to three dimensional (3D) space by using 3D reconstructed data to realize accurate object counting, identification, scene re-organization, and so on in accordance with the desired implementation. Through the example implementations described herein, more accurate objection detection can be provided than regular 2D object detection.

### BACKGROUND

### Field

The present disclosure relates generally to object detection technologies to find object location in images, and more specifically, through conducting object detection from integrating 2D image recognition and 3D scene reconstruction.

### Related art

Object detection for two dimensional (2D) still images have been implemented in the related art, including pixel-based template matching methods, specific pattern detection methods such as a method using Hough transformation, and methods using machine learning. For object detection using machine learning, face detection technology based on Haar-like features and cascaded classifiers has been implemented in the related art. In addition, methods using deep neural networks which facilitate simultaneous learning of image features and object localization have led to high-accuracy multi-class object detection.

Recently, with the development of depth sensors and related computer vision technologies, the use of three dimensional (3D) data became easier, and object detection methods for 3D have been proposed in the related art, such as deep neural networks taking 3D point clouds as input. Other related art implementations of handling voxel data and mesh data have also been utilized.

In the related art, there are techniques for 3D analysis of a scene including detection, segmentation and registration of objects within the scene. The analysis results may be used to implement augmented reality operations including removal and insertion of objects and the generation of blueprints. An example related art method may include receiving 3D image frames of the scene, each frame associated with a pose of a depth camera, and creating a 3D reconstruction of the scene based on depth pixels that are projected and accumulated into a global coordinate system. The related art method may also include detecting objects, and associated locations within the scene, based on the 3D reconstruction, the camera pose and the image frames. The related art method may further include segmenting the detected objects into points of the 3D reconstruction corresponding to contours of the object and registering the segmented objects to 3D models of the objects to determine their alignment.

### SUMMARY

Example implementations described herein address the above problems for object detection technologies for a real-world scene. The example implementations described herein are directed to the counting of industrial parts such as stacked pipes, but can be extended to other situations in accordance with the desired implementation.

Aspects of the present disclosure can include a method, involving conducting raycasting on a plurality of images to generate a point cloud; executing two dimensional (2D) object detection on the plurality of images; for the 2D object detection recognizing an object, determining a location of the object in three dimensional (3D) space from the point cloud; for the location not overlapping another marker, classifying the object from the 2D object detection; and placing a marker in the 3D space to represent the object based on the classifying.

Aspects of the present disclosure can include a non-transitory computer readable medium, having instructions involving conducting raycasting on a plurality of images to generate a point cloud; executing two dimensional (2D) object detection on the plurality of images; for the 2D object detection recognizing an object, determining a location of the object in three dimensional (3D) space from the point cloud; for the location not overlapping another marker, classifying the object from the 2D object detection; and placing a marker in the 3D space to represent the object based on the classifying.

Aspects of the present disclosure can include a system, involving means for conducting raycasting on a plurality of images to generate a point cloud; means for executing two dimensional (2D) object detection on the plurality of images; for the 2D object detection recognizing an object, means for determining a location of the object in three dimensional (3D) space from the point cloud; for the location not overlapping another marker, means for classifying the object from the 2D object detection; and means for placing a marker in the 3D space to represent the object based on the classifying.

Aspects of the present disclosure can include an apparatus, involving a processor, configured to conduct raycasting on a plurality of images to generate a point cloud; execute two dimensional (2D) object detection on the plurality of images; for the 2D object detection recognizing an object, determine a location of the object in three dimensional (3D) space from the point cloud; for the location not overlapping another marker, classify the object from the 2D object detection; and place a marker in the 3D space to represent the object based on the classification.

### BRIEF DESCRIPTION OF DRAWINGS

FIGS. 1(a) and 1(b) illustrate examples of scenarios involving stacked pipes that have problems for single-view image recognition.

FIG. 2 illustrates an example of problems that occur in multi-view image recognition.

FIG. 3 illustrates an example of problems that occur in 3D data recognition.

FIGS. 4(a) to 4(c) illustrates an example processing procedure for integrating 2D object detection and 3D image reconstruction, in accordance with an example implementation.

FIG. 5 illustrates an example of collision detection to avoid duplicated object detection, in accordance with an example implementation.

FIG. 6 illustrates an example of integration of multi-view 2D object detection by using 3D information, in accordance with an example implementation.

FIG. 7 illustrates an example diagram of the overall system upon which example implementations may be applied.

FIG. 8 illustrates an example hardware diagram upon which the overall system of FIG. 7 may be applied.

FIG. 9 illustrates an example processing flow for realizing the processes described herein, in accordance with an example implementation.

FIG. 10 illustrates an example of integrating recognition results obtained from multiple viewpoints, in accordance with an example implementation.

FIGS. 11(a) to 11(d) illustrate example interfaces for asset inventory management, in accordance with an example implementation.

FIG. 12 illustrates an example implementation for an interface for image inspection or video surveillance.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

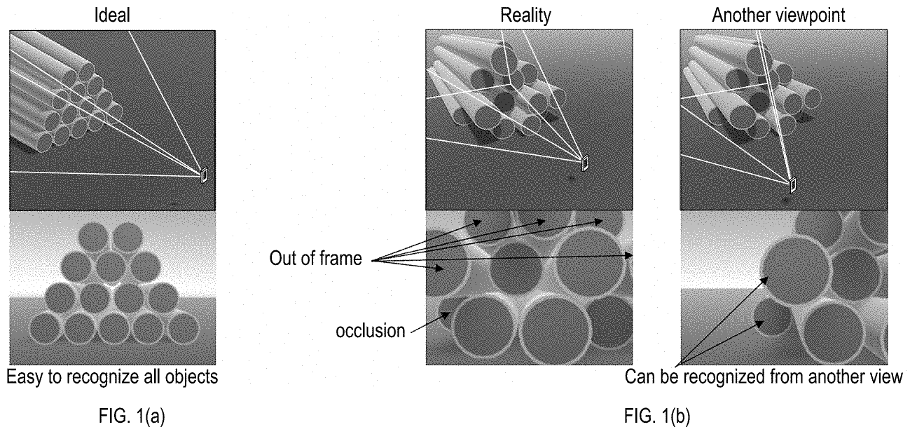

In the related art, there are problems that occur in single-view image recognition as illustrated in FIGS. 1(a) and 1(b) with an example of stacked pipes. As illustrated in FIG. 1(a), when multiple objects are properly aligned and a picture is taken from the front of the objects, it is possible to detect the objects with high accuracy by using related art object detection technologies. However, in real situations, objects are cluttered as show in FIG. 1(b). In addition, there are cases in which the distance between the objects and the camera is short, or the photo cannot be taken from the front of the objects. In such cases, some of the objects are occluded or framed out in the photo image. In the existing object detection technologies, detection accuracy drops significantly when the object is partially occluded, and it is also impossible to detect invisible objects that are fully occluded. Therefore, it is necessary to move the camera and capture objects from another viewpoint.

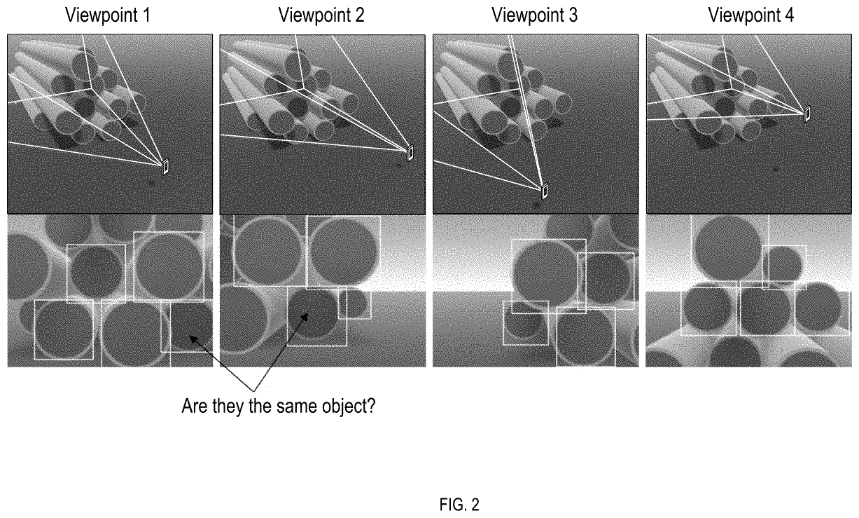

FIG. 2 illustrates an example of problems that occur in multi-view image recognition. As shown in FIG. 2, by capturing from multiple viewpoints, it is possible to obtain images that can be recognized to detect all objects, except in the case where some objects are completely obscured. However, since there is a possibility that one object appears in different images of viewpoints, double counting will occur. Object tracking technologies for matching an object across multiple frames has been proposed in the related art. But when object appearance is similar, occlusion occurs frequently. Further, if the frame rate is insufficient, accurate tracking can be difficult.

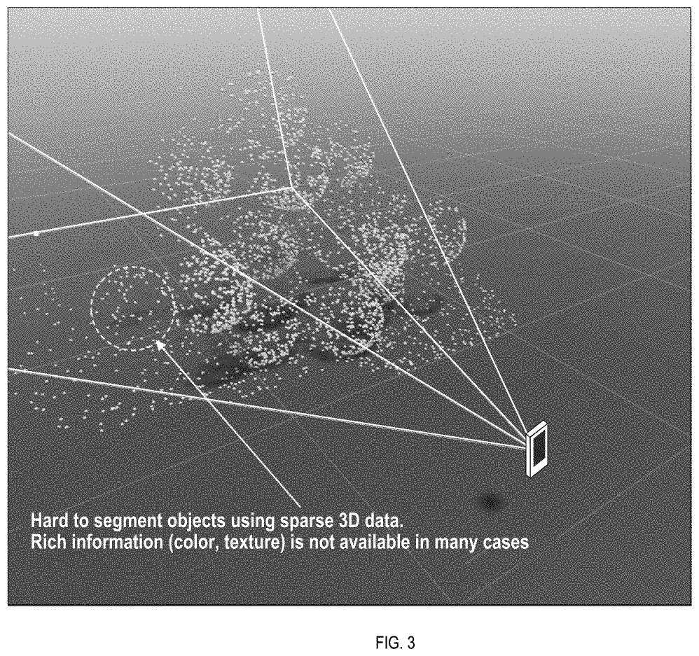

FIG. 3 illustrates an example of problems that occur in 3D data recognition. With the development of depth sensors and related technologies, use of 3D data became easier, and object detection for point cloud as shown in FIG. 3 has been proposed in the related art. However, with inexpensive sensors and computing resources, only sparse point clouds can be obtained. In addition, there are few cases in which additional information such as color or texture can be used. In such cases, it is difficult to detect densely aligned objects as individual instances.

In example implementations described herein, object detection is performed on a 2D still image, wherein the detection results are projected onto a 3D reconstructed space, and 3D positions of objects are specified. Markers corresponding to each object are placed at corresponding positions in the 3D space. The above processing is performed on images from multiple viewpoints. For a newly detected object, collision detection with existing markers is performed, and if a marker already exists, a new marker is not placed.

In example implementations described herein, object detection is performed on images from multiple viewpoints, whereby object detection becomes robust to occlusion and frame-out. Since the 3D data is not directly used for object detection but is used for estimating and managing the positions of detected objects in the 3D space, the data can be applied to a sparse point cloud with less information (without color or texture). Double counting can be prevented when integrating the detection results of multiple viewpoints by managing the object position in the 3-dimensional space and performing collision detection.

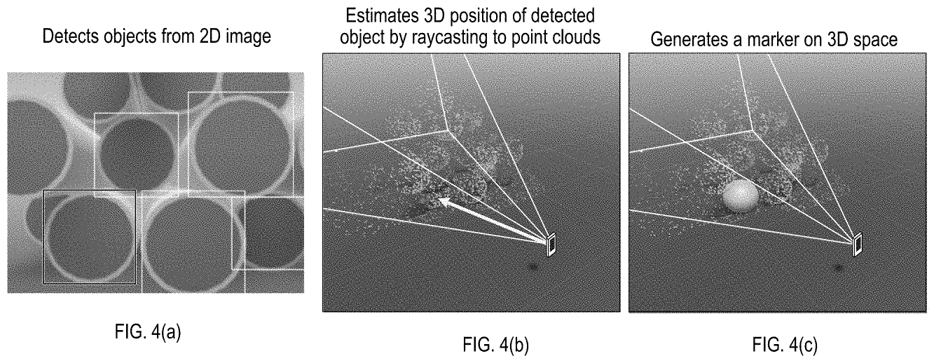

FIGS. 4(a) to 4(c) illustrates an example processing procedure for integrating 2D object detection and 3D image reconstruction, in accordance with an example implementation. The example as provided for FIGS. 4(a) to 4(c) are with respect to counting pipes, however, the example implementations can be applied to image recognition targeting any arbitrary object in accordance with the desired implementation.

In example implementations, there is a 2D image acquisition unit and a 3D data acquisition unit. The 2D image acquisition unit can include any general camera capable of capturing still images in accordance with the desired implementation. The 3D data acquisition unit may use a depth sensor, or may calculate 3D information from still images by computer vision technologies, or through any other implementation in accordance with the desired implementation. In addition, to improve the accuracy of scene reconstruction and self-positioning, information such as an acceleration sensor (e.g., accelerometer) may be used. The 2D image acquisition unit and 3D data acquisition unit are calibrated so that correspondence between position data can be obtained.

In this system, object detection is first performed on a 2D image. As a result, coordinates of objects in the image can be obtained. FIG. 4(a) illustrates an example of detecting objects from 2D images by representing the coordinates of the detected objects with bounding boxes. Detection may fail for partially occluded or framed out objects.

Next, the system calculates the 3D coordinates of the detected object. In this system, by projecting from 2D coordinates of a detected object to 3D data (e.g. point cloud, voxel, mesh), the position of the 3D space is estimated as shown in FIG. 4(b), which illustrates an example of estimating the 3D position of detected objects by raycasting to point clouds. The system can project multiple 2D points in the bounding box of detected object to improve the accuracy of 3D position estimation. The raycasting can be implemented through any implementation known in the art.

Then, the system places one or more markers on the obtained 3D coordinates as shown in FIG. 4(c). The marker is recorded as a 3D object having a size. This operation is performed for all detected objects.

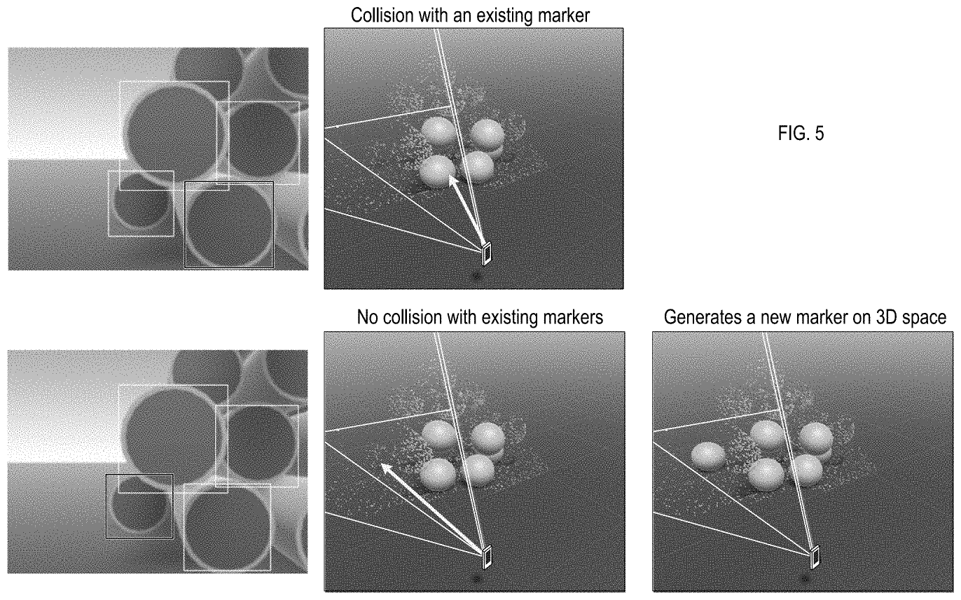

After processing from one viewpoint, the user moves the data acquisition unit and obtains an image from another viewpoint. FIG. 5 illustrates an example of collision detection to avoid duplicated object detection, in accordance with an example implementation. As shown in FIG. 5, when the 3D position is estimated, collision detection with existing markers is performed. Based on the result of the collision detection, if a marker already exists on the same position, new marker is not placed. If there is no marker, then a new marker is generated on 3D space.

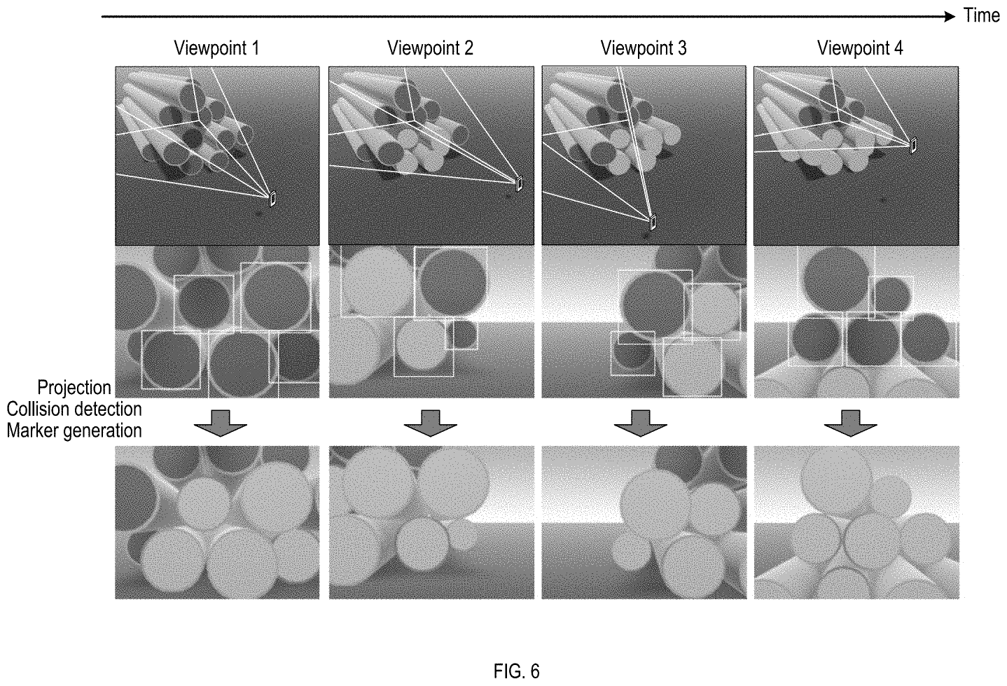

FIG. 6 illustrates an example of integration of multi-view 2D object detection by using 3D information, in accordance with an example implementation. Specifically, FIG. 6 illustrates how the processes as illustrated in FIGS. 4(a) to 5 are repeated from multiple viewpoints to update information stored on 3D space. As a result of utilizing multiple viewpoints, it is possible to detect objects aligned randomly, without missed or double detection.

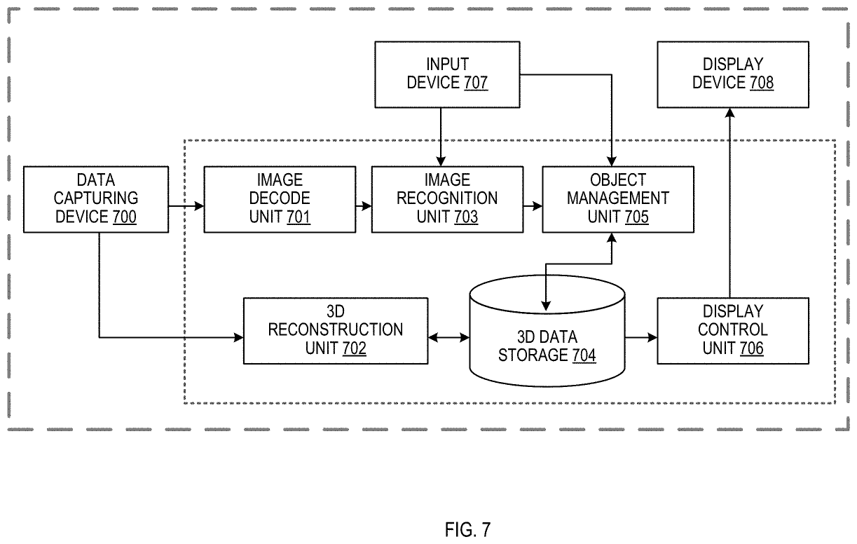

FIG. 7 illustrates an example diagram of the overall system upon which example implementations may be applied. The system can involve a data capturing device 700, an image decode unit 701, a 3D reconstruction unit, an image recognition unit 703, a 3D data storage 704, an object management unit 705, a display control unit 706, an input device 707, and a display device 708. Data capturing device 700 can involve a user device such as a smartphone or other mobile device that has a camera. Input device 707 can include an interface for facilitating inputs and outputs such as a touch screen on the mobile device. Display device 708 can involve a display screen such as a display screen on the mobile device.

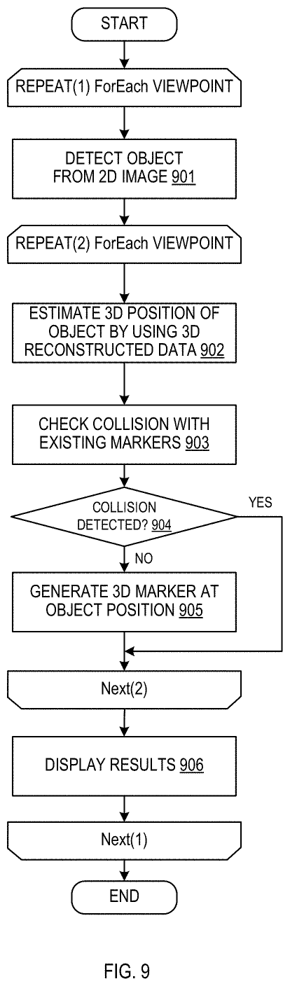

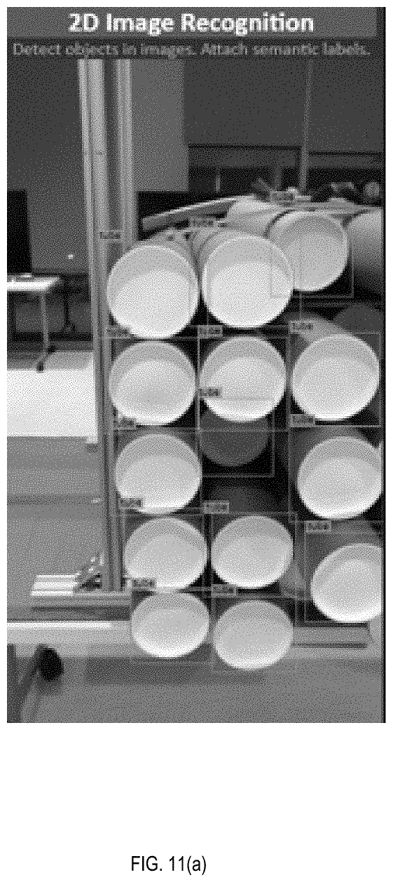

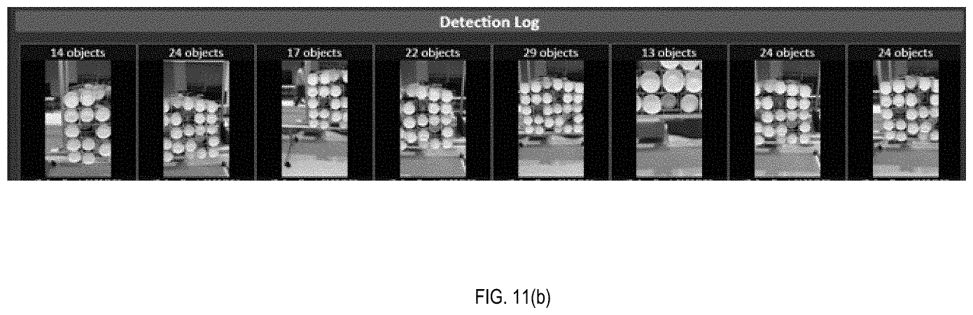

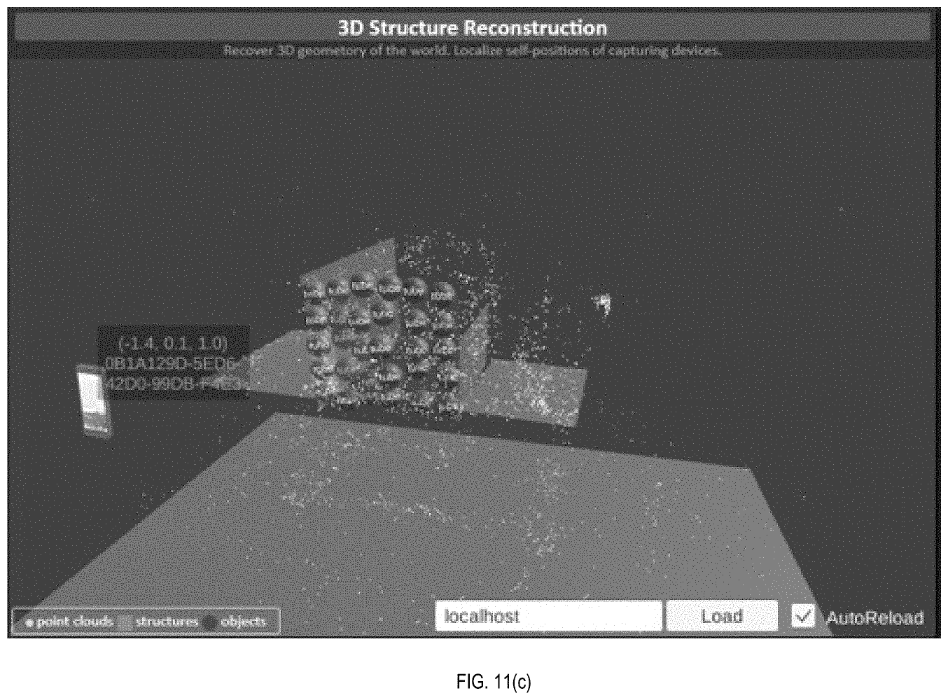

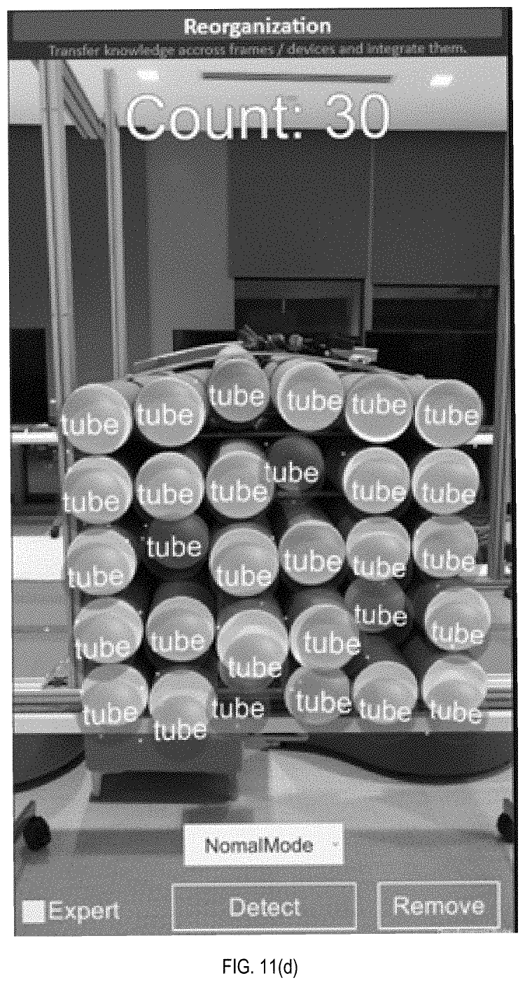

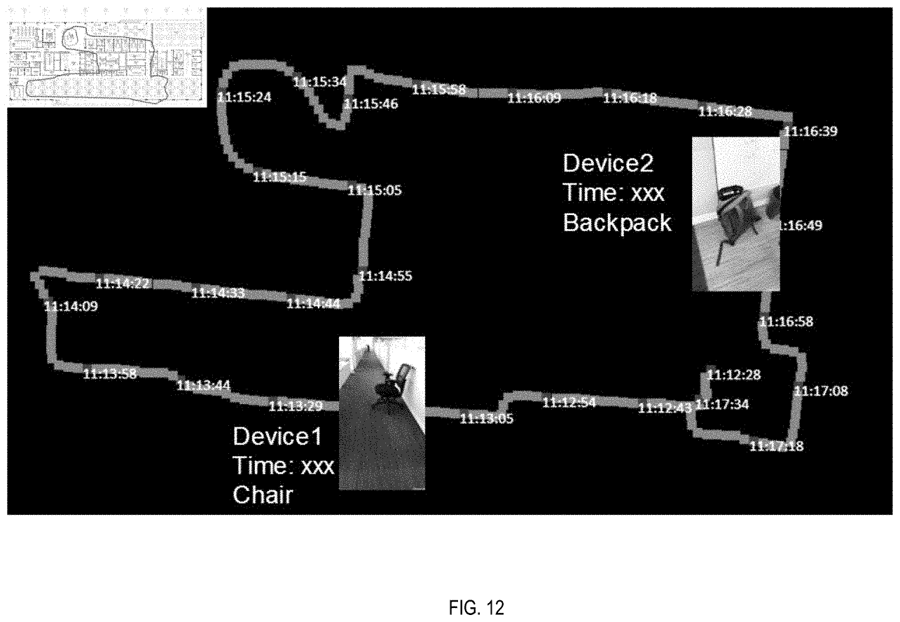

Depending on the desired implementation, image decode unit 701, image recognition unit 703, object management unit 705, 3D reconstruction unit 702, 3D data storage 704 and display control unit 706 can reside on an external server configured to conduct background processing on the images received from data capturing device 700. 3D reconstruction unit 702 can be configured to facilitate the functions as illustrated in FIGS. 3, 4(b), 4(c), 5, and 11(c). 3D data storage 704 can be configured for storing the 3D space with all of the markers. Image recognition unit 703 can be configured to facilitate the functions as illustrated in FIGS. 4(a), 11(a) and 11(b). Object management unit 705 can manage the objects that are identified based on the 2D recognition and 3D recognition through the flow diagram of FIG. 9 and through receiving user input for implementations such as shown in FIG. 11(d). Display control unit 706 can be configured to provide interfaces to the user device and display such interfaces on the display device 708, as shown in the examples of FIGS. 11(a) to 11(d) and FIG. 12.

Example functions that can be implemented from the system to facilitate the example implementations described herein can involve the following. To facilitate example implementations, there may need to be a function to correct for the starting point of the projection. For example, object detection may take some time to conduct, wherein the time lag between capturing the image from the data capturing device 700 and projecting detection results from the display control unit 706 may cause a misalignment of 3D position. Thus in example implementations described herein, the device position at which the 2D image is captured is also stored by the system. The stored position can then be used to project detection results in accordance with the desired implementation, and as shown at FIGS. 11(c) and 11(d). Depending on the configuration of the data capturing device 700, should such a device be configured with an accelerometer, then the accelerometer information can also be utilized to correct for the position of the device.

In another example function, object management unit 705 can be configured to re-project old detection results after 3D point clouds become dense enough for projection, if projection of detection results fail due to the 3D point clouds being sparse. In such example implementations, the projection of results can be delayed until sufficient density of 3D point clouds is obtained.

In another example function, object management unit 705 can be configured to search the vacant space in 3D space to determine appropriate camera angles from which such spaces can be seen. In such an example implementation, the display control unit 706 can thereby provide a recommendation to the user of the data capturing device 700 to move the device to an appropriate position and angle to capture more areas so that object recognition can become more accurate. In such manner, the appropriate viewpoints as shown in FIG. 6 can be obtained.

Functions can also be provided to extend example implementations to moving objects. In such an example implementation, upon placing a marker as shown in FIG. 5, the projection can be reversed against the images in the 2D object recognition for subsequent images. If the object is no longer detected in the 2D image, then the corresponding marker can be deleted in the 3D space. Such a process can be conducted iteratively before placing a marker so that new markers can be placed in 3D space continuously in response to a moving object.

Functions can also be provided to facilitate capture from multiple devices, an example of which is provided in FIG. 12. To facilitate capture from multiple devices, duplication in counting must be taken into consideration. In such example implementations, the devices can share information (e.g. 3D point clouds, position of detected objects, positions of devices) over a network through a network interface. In an example implementation, a server implementing the functions as described in the units can also broadcast such information to the devices in accordance with the desired implementation, and manage a database to intake all data received from all devices and share accordingly.

Functions can also be provided to improve the projection of point clouds if the point clouds are insufficiently dense. In such an example implementation, structures can also be generated (e.g., mesh, plane) as illustrated in FIG. 11(c), whereupon example implementations can project to the structure to improve the projection. For example, the structure can be used as a border for a group of objects. In another example implementation, multiple points in the point cloud can be utilized to estimate a position of the object in accordance with a desired implementation. Such functions can also address false positives of 2D object detection by providing context of the 3D space through the structures in complicated scenarios such as an outdoor scenario with multiple different types of objects. In an example, the projected structures can prevent the false detection of objects such as clouds in the sky.

Example implementations can also adjust the size of the marker depending on the size of the object. Such example implementations can address potential failure of detecting collisions due to the marker size being too big or too small. Thus, depending on the type of objects to be detected, the marker size can be adjusted according to the desired implementation and/or the range of collision can be similarly adjusted to compensate for the sizes of different types of objects. Example implementations can also improve collision detection during the 2D object detection through considering the type of object as described to address complicated scenarios in which there are multiple different types of objects, or densely aligned objects. In such example implementations, a reliability score can also be assigned to detected 2D objects to provide an assessment of the confidence of the detection. Such a reliability score can be conducted through any desired implementation.

Example implementations can also provide an interactive interface, as there may be errors in object detection through 2D recognition. In such an example implementation, an interface is provided as shown at FIG. 11(a) or FIG. 11(d) in which objects can be added or deleted by tapping on a touch screen (e.g., to remove bounding boxes or markers appropriately in accordance with the desired implementation). The starting point of the projection can be calculated from the position of the device, in accordance with the desired implementation.

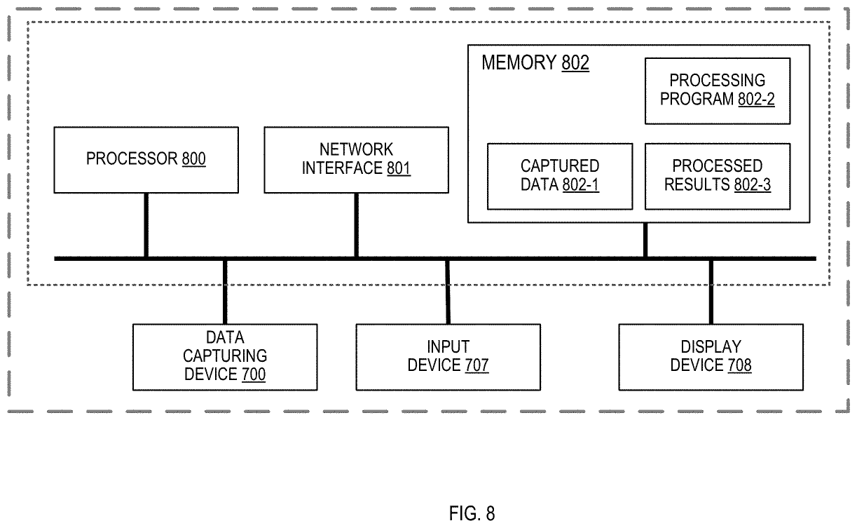

FIG. 8 illustrates an example hardware diagram upon which the overall system of FIG. 7 may be applied. The system can involve a processor 800, a network interface 801, and a memory 802. Memory 802 can be configured to manage captured data 802-1, processing program 802-2, and processed results 802-3. Network interface 801 is configured to facilitate communication between mobile devices that provide the functionality for the data capturing device 700, the input device 707, and the display device 708 to the processor 800, which can be incorporated into a server to handle backend functions in accordance with the desired implementation. In another example implementation, the entire system may reside on one mobile device, such as a laptop. Captured data 802-1 is configured to store images received from data capturing device 700. Processing program 802-2 is configured to execute the functionality of image decode unit 701, image recognition unit 703, 3D reconstruction unit 702, object management unit 705, and display control unit 706, in accordance with the desired implementation, as well as the flow of FIG. 9, and is executed when loaded into processor 800. Processor 800 can be in the form of physical hardware processors such as central processing units (CPUs) or a combination of hardware and software processors depending on the desired implementation. Processed results 802-3 is configured to store 3D data storage 704 involving the point clouds and markers projected in 3D space.

In an example implementation, processor 800 can be configured to conduct raycasting on a plurality of images to generate a point cloud as illustrated in FIGS. 4(b) and 11(c); execute two dimensional (2D) object detection on the plurality of images as illustrated in FIGS. 4(a) and 11(a), and for the 2D object detection recognizing an object as illustrated with the bounding of FIGS. 4(a) and 11(c), determine a location of the object in three dimensional (3D) space from the point cloud as illustrated in FIGS. 4(b) and 4(c); for the location not overlapping another marker as illustrated in FIG. 5, classify the object from the 2D object detection based on, for example, object type as described in FIG. 7; and place a marker in the 3D space to represent the object based on the classification as illustrated in FIGS. 5, 11(c) and 11(d).

In example implementations, the plurality of images as illustrated in FIG. 6 or FIG. 11(b) can be associated one or more of a position and acceleration of a device that captured the plurality of images. In an example, the position can be measured from a global positioning satellite (GPS) sensor of the data capturing device 700 or other methods in accordance with the desired implementation. The acceleration of the data capturing device 700 can be measured with an accelerometer or otherwise in accordance with the desired implementation. Such information can be provided with the plurality of images in the form of metadata, or streamed to processor 800 depending on the desired implementation. In such example implementations, processor 800 can be configured to project the 3D space for display on the device based on the one or more of the position and acceleration of the device as shown in FIGS. 11(c) and 11(d).

In example implementations, processor 800 can be further configured to, for the point cloud not meeting a sufficient density, project additional points from a database of previously raycast point clouds based on the one or more of the position and acceleration of the device. In such example implementations, 3D data storage 704 may manage point clouds as raycast previously from the device or from other devices. Such points can be provided to fill in the point clouds to the data capturing device 700 to speed up implementations of 2D to 3D processing. The density can be in accordance with a threshold as set to the desired implementation.

In example implementations, processor 800 can be configured to search the 3D space for one or more vacant areas; and generate a recommendation for the device involving a position and angle to conduct image capture based on the one or more vacant areas. In an example implementation, the searching of the 3D space can be conducted based on the point cloud density of a particular area as stored in 3D data storage 704 and as illustrated in FIG. 11(c). If the point cloud density is below a threshold as set in accordance with the desired implementation, instructions regarding a position and angle can be transmitted to the data capturing device 700 in accordance with an desired implementation to capture the area. In an example, the position and angle can be determined based on the coordinates within the 3D space, and translated over to GPS coordinates and orientation in accordance with any desired implementation. Such information can be overlaid on an interface as shown in FIG. 11(d).

Processor 800 can also be further configured to provide an interface to the device configured to add or remove one or more objects detected in the 2D object detection from the plurality of images as illustrated in FIG. 11(a) and FIG. 11(d). In such an implementation, the bounding boxes in the 2D image recognition interface of FIG. 11(a) can be selectable (e.g., through a touch screen) and bounding boxes can be added or removed in accordance with the desired implementation. Similarly, the markers as illustrated in the interface of FIG. 11(d) can be selectable (e.g., through a touch screen) and added or removed in accordance with the desired implementation.

Processor 800 can also be configured to classify the object from 2D detection by determining a type of the object and determining a size of the marker from the type of the object as described with respect to FIG. 7. In such example implementations, object types (e.g., pipe versus computer versus cardboard box) can be provided with different size markers based on their size relative to each other. Such sizes can be assigned in accordance with the desired implementation. The object recognition to classify such objects can be conducted in accordance with any desired implementation as known in the art, and the marker sizes can be managed in a database in memory 802 to facilitate the marker sizes.

FIG. 9 illustrates an example processing flow for realizing the processes described herein, in accordance with an example implementation. For each view point, a first process is iteratively executed for each viewpoint. In the first process, at 901, an object is detected from a 2D image. Within the first process, a second process is iteratively executed for each viewpoint. In the second process, at 902, the flow estimates the 3D position of the object by using 3D reconstructed data. At 903, a check is made for collision with existing markers. At 904, if such a collision is detected (Yes), then the flow reiterates the second process on the next viewpoint, otherwise (No), the flow proceeds to 905 to generate a 3D marker at the object position and reiterate the second process for the next viewpoint. At 906, the flow displays results, and then the first process is reiterated for the next viewpoint. The first and second processes are reiterated until all viewpoints are traversed.

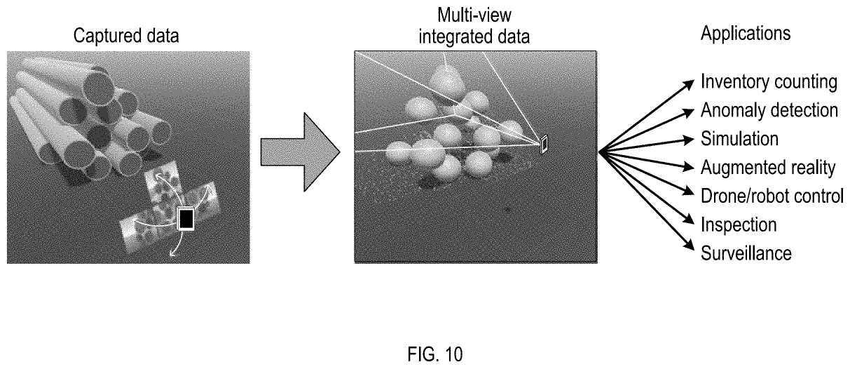

FIG. 10 illustrates an example of integrating recognition results obtained from multiple viewpoints, in accordance with an example implementation. As shown in FIG. 10, the captured data involves multiple images taken over multiple viewpoints, which are translated into a multi-view integrated data that can be applied to various applications in accordance with the desired implementation, such as but not limited to inventory counting, anomaly detection, simulation, augmented reality (AR), robot control, image inspection and video surveillance.

FIGS. 11(a) to 11(d) illustrate example interfaces for asset inventory management, in accordance with an example implementation. By grasping accurate inventory in a short time, the example implementations can reduce labor costs and surplus inventory management costs. Specifically, FIG. 11(a) illustrates an example interface panel that can be shown on a user device such as a mobile device (e.g., smartphone), for conducting 2D image recognition. The 2D image recognition generates bounding boxes which are placed on all detected objects in accordance with the desired implementation. FIG. 11(b) illustrates another example interface panel that indicates a detection log for objects captured by the 2D object recognition. As the user captures multiple images through the camera of the mobile device, the detection log maintains a log of all images captured along with the corresponding 2D image recognition for processing in the 3D object reconstruction. FIG. 11(c) illustrates an example interface panel that indicates a 3D structure reconstruction derived from the 2D image recognition. Through the point cloud and marker projection processes as described herein, the example implementations can determine the 3D structure of the environment and the objects detected therein. In the interface of FIG. 11(c), the interface can indicate the location of the mobile device relative to the detected objects, the structures (e.g., walls, floor) in proximity to the mobile device, the point clouds, and the detected objects in the form of markers.

The interface panel shown on FIG. 11(d) is an example screen that the user sees using a mobile device such as a smartphone. By using this system, it is possible to automatically count the number of assets from images taken with a mobile device camera. Also, by moving the smartphone, it is possible to integrate the results of capturing from multiple viewpoints and display the total count. In addition, by overlaying detected objects on the screen, the user can easily confirm the recognition result, and perform manual correction in accordance with the desired implementation.

FIG. 12 illustrates an example implementation for an interface for image inspection or video surveillance. By recording the time at which images are acquired and positions of specific objects on the 3D space, it is possible to realize image inspection and monitoring over a wide area where the fixed surveillance camera cannot be used. In addition, according to the example implementations, 3D data can be shared by multiple devices, so that it is possible to grasp the wide area in a short time by collaborative image recognition using a large number of devices. In the example of FIG. 12, images were taken from cameras from security robots. The robot traversed the floor of the building as shown in the upper left thumbnail the building floor. The pathway illustrated in FIG. 12 indicates the time stamp in which images were taken, the robot in question (e.g., Device 1, Device 2), and when a trigger event occurred for detecting an unexpected object (e.g., chair, backpack). From the example implementations described herein, object recognition can be continuously conducted to identify objects that are unexpected in certain locations.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
conducting raycasting on a plurality of images to generate a point cloud;
executing two dimensional (2D) object detection on the plurality of images;
for the 2D object detection recognizing an object:
determining a location of the object in three dimensional (3D) space from the point cloud;
for the location not overlapping another marker:
classifying the object from the 2D object detection; and
placing a marker in the 3D space to represent the object based on the classifying.

2. The method of claim 1, wherein the plurality of images are associated with one or more of a position and acceleration of a device that captured the plurality of images;
wherein the method further comprises projecting the 3D space for display on the device based on the one or more of the position and acceleration of the device.

3. The method of claim 2, further comprising, for the point cloud not meeting a sufficient density, projecting additional points from a database of previously raycast point clouds based on the one or more of the position and acceleration of the device.

4. The method of claim 2, further comprising:
searching the 3D space for one or more vacant areas; and
generating a recommendation for the device comprising a position and angle to conduct image capture based on the one or more vacant areas.

5. The method of claim 2, further comprising providing an interface to the device configured to add or remove one or more objects detected in the 2D object detection from the plurality of images.

6. The method of claim 1, wherein the classifying the object from the 2D detection comprises determining a type of the object, and determining a size of the marker from the type of the object.

7. A non-transitory computer readable medium, storing instructions for executing a process, the instructions comprising:
conducting raycasting on a plurality of images to generate a point cloud;
executing two dimensional (2D) object detection on the plurality of images;
for the 2D object detection recognizing an object:
determining a location of the object in three dimensional (3D) space from the point cloud;
for the location not overlapping another marker:
classifying the object from the 2D object detection; and
placing a marker in the 3D space to represent the object based on the classifying.

8. The non-transitory computer readable medium of claim 7, wherein the plurality of images are associated with one or more of a position and acceleration of a device that captured the plurality of images;
wherein the instructions further comprises projecting the 3D space for display on the device based on the one or more of the position and acceleration of the device.

9. The non-transitory computer readable medium of claim 8, the instructions further comprising, for the point cloud not meeting a sufficient density, projecting additional points from a database of previously raycast point clouds based on the one or more of the position and acceleration of the device.

10. The non-transitory computer readable medium of claim 8, the instructions further comprising:
searching the 3D space for one or more vacant areas; and
generating a recommendation for the device comprising a position and angle to conduct image capture based on the one or more vacant areas.

11. The non-transitory computer readable medium of claim 8, the instructions further comprising providing an interface to the device configured to add or remove one or more objects detected in the 2D object detection from the plurality of images.

12. The non-transitory computer readable medium of claim 8, wherein the classifying the object from the 2D detection comprises determining a type of the object, and determining a size of the marker from the type of the object.

13. An apparatus, comprising:
a processor, configured to:
conduct raycasting on a plurality of images to generate a point cloud;
execute two dimensional (2D) object detection on the plurality of images;
for the 2D object detection recognizing an object:
determine a location of the object in three dimensional (3D) space from the point cloud;
for the location not overlapping another marker:
classify the object from the 2D object detection; and
place a marker in the 3D space to represent the object based on the classification.

14. The apparatus of claim 13, wherein the plurality of images are associated with one or more of a position and acceleration of a device that captured the plurality of images;
wherein the processor is configured to project the 3D space for display on the device based on the one or more of the position and acceleration of the device.

15. The apparatus of claim 14, the processor further configured to, for the point cloud not meeting a sufficient density, project additional points from a database of previously raycast point clouds based on the one or more of the position and acceleration of the device.

16. The apparatus of claim 14, the processor further configured to:
search the 3D space for one or more vacant areas; and
generate a recommendation for the device comprising a position and angle to conduct image capture based on the one or more vacant areas.

17. The apparatus of claim 14, the processor further configured to provide an interface to the device configured to add or remove one or more objects detected in the 2D object detection from the plurality of images.

18. The apparatus of claim 14, wherein the processor is configured to classify the object from the 2D detection by determining a type of the object, and determining a size of the marker from the type of the object.
